(19) United States
(12) Patent Application Publication
(10) Pub. No.: US 2007/0090767 A1
(43) Pub. Date: Apr. 26, 2007

(54) Lighting system with multi-ballast AC-to-DC converter

(75) Inventor: Victor David Roberts, Burnt Hills, NY (US)

Correspondence Address: YOUNG & BASILE, P.C., 3001 WEST BIG BEAVER ROAD, SUITE 624, TROY, MI, 48084, US

(73) Assignee: American Electrolier, Inc., Vero Beach, FL (US)

(21) Appl. No.: 11/399,276

(22) Filed: Apr. 6, 2006

Related U.S. Application Data
(60) Provisional application No. 60/729,491, filed on Oct. 24, 2005.

(51) Int. Cl. H05B 41/16

(52) U.S. Cl. 315/139

(57) ABSTRACT

A lighting system having one three-phase AC-to-DC converter, each connected to a plurality of DC-powered electronic ballasts for operating lamps. The three-phase AC-to-DC converter uses six rectifier diodes connected in a full-wave bridge configuration, does not contain a line frequency energy storage capacitor and is typically designed to operate more than one DC-powered electronic ballast. The AC-to-DC converter may be installed in a three-pole circuit breaker case so it can be mounted in a standard breaker panel. The three-phase AC-to-DC converter provides DC power with a low level of ripple to power the DC-powered electronic ballasts. The DC-powered electronic ballasts are connected to the three-phase AC-to-DC converter using two power wires plus a protective ground. Each of the DC-powered electronic ballasts contains a filter circuit connected between the power switching circuitry and the DC power input to prevent electromagnetic interference EMI. The DC-powered electronic ballasts or drivers do not contain line frequency energy storage capacitors, but they do contain at least one small capacitor that functions as the “return connection” for high frequency signals generated by the power switching circuitry.

### CROSS REFERENCE TO CO-PENDING APPLICATION.

This application claims the benefit of the filing date of U.S. Provisional Patent Application, filed Oct. 24, 2005, Ser. No. 60/729,491 in the name of Victor David Roberts and entitled “Lighting System of Multi-Ballast AC-to-DC Converter.”

### BACKGROUND OF THE INVENTION

1. Field of the Invention

This invention relates generally to electronic equipment, including lighting systems that use electronic ballasts or drivers. More specifically it pertains to a lighting system that includes one or more electronic ballasts or drivers, each used to operate one or more electrically powered lamps.

2. Description of the Art

In the lighting industry, gas discharge lamps, such as fluorescent lamps, are widely used for their ability to generate light with low heat and long term use.

In a typical gas discharge building lamp circuit, single phase, 120 VAC electric power is coupled to a ballast mounted in each lamp fixture which typically contain from one to four gas discharge bulbs. The ballast typically includes single phase electromagnetic interference filter, a full wave diode bridge, a power factor correction circuit, a capacitor, and a high frequency inverter.

The power factor correction circuit is required to maintain a sufficiently high power factor. However, a dedicated power factor correction circuit is costly, requires a large physical space, and introduces power losses which decrease the efficiency of the ballast. The ballast components also generate heat which significantly degrades the operation of the ballast components over time.

Recently, a three-phase electronic ballast has been proposed in which each ballast includes an EMI filter, an AC-to-DC rectifier circuit, a high frequency filter capacitor and a high frequency inverter driving one or more lamps. Each ballast has all three phase and a ground lead connected to an AC power source.

This arrangement requires that three-phase AC power be supplied to each ballast in each lamp fixture. As such, retrofitting this three-phase electronic ballast into existing building wiring which typically employs the single phase AC power source, typically coupled through a circuit breaker panel to each individual ballast is difficult.

Thus, it would be desirable to provide an apparatus or lighting apparatus using a single AC-to-DC converter or rectifier to supply DC voltage power to multiple ballasts or inverters to overcome the deficiencies of prior art ballasts using AC-to-DC converters or using individual three-phase AC-to-DC converters.

### SUMMARY OF THE INVENTION

In view of the limitations now present in the prior art, the present invention provides a new and useful lighting system using DC-powered ballasts or drivers and one multi-ballast AC-to-DC converter. This lighting system is simpler in construction, more reliable, more efficient and lower in cost than known apparatus of this kind.

The present invention generally comprises one AC-to-DC converter and one or more electronic ballasts or drivers designed to operate electrically powered lamps such as discharge lamps, including fluorescent lamps, metal halide lamps, high pressure sodium lamps, or high pressure mercury lamps; or solid state lamps, such as light emitting diodes LEDs or organic light emitting diodes OLEDs. The electronic ballasts or drivers are each designed to be powered by direct current DC. The AC-to-DC converter contains six rectifiers and is designed to draw power from three-phase power sources. The output of this AC-to-DC converter is low-ripple DC. Each AC-to-DC converter is designed to operate one or more electronic ballasts or drivers. The input of the AC-to-DC converter is connected to a source of three-phase AC power, while the output of the AC-to-DC converter is connected to one or more DC-powered ballasts or drivers. The AC-to-DC converter may be centrally located near the source of three-phase AC power, while the DC power is transmitted to the DC-powered ballasts or drivers over reasonable long distances using two conventional wires plus a protective ground. The present invention can also be used with electronic equipment other than lighting equipment such as, but not limited, to computer servers.

The present invention provides a lighting system using a multi-ballast AC-to-DC converter that will overcome the deficiencies of the prior art devices.

An object of the present invention provides a lighting system using a multi-ballast AC-to-DC converter that provides higher reliability and lower cost than existing lighting systems.

The present invention provides a lighting system using a multi-ballast AC-to-DC converter that provides an input power factor equal to or greater than 0.9 and a low degree of light modulation while not using a line frequency energy storage capacitor.

The present invention provides a lighting system using a multi-ballast AC-to-DC converter that provides an input power factor equal to or greater than 0.9 and a low degree of light modulation while not using a power factor correction circuit.

The present invention provides a lighting system using a multi-ballast AC-to-DC converter that is powered by three-phase AC power.

The present invention provides a lighting system using one or more multi-ballast AC-to-DC converters, each of which can operate one or more DC-powered electronic lamp ballasts or drivers.

The present invention provides a lighting system using a multi-ballast AC-to-DC converter where the AC-to-DC converter can be built into the case of a three-pole circuit breaker so that the AC-to-DC converter can be mounted in a standard breaker box supplied with three-phase AC power.

The present invention provides a lighting system using a multi-ballast AC-to-DC converter that uses the existing building wiring, generally consisting of two power wires and a protective ground, to connect the AC-to-DC converter to the DC-powered ballasts or drivers.

The present invention provides a lighting system using a multi-ballast AC-to-DC converter that can be used to operate discharge lamps, such as fluorescent, high pressure sodium, metal halide, or low pressure sodium lamps; or solid state lamps, such as light emitting diodes or organic light emitting diodes.

The present invention provides a lighting system using a multi-ballast AC-to-DC converter that uses DC-powered ballasts or drivers that include electromagnetic interference EMI filters and one or more small value high frequency return capacitors.

The present invention provides a lighting system using a multi-ballast AC-to-DC converter that is more universally functional in today's market than the prior art devices.

An apparatus for supplying power from a three-phase AC electrical power source to a DC load includes a three-phase rectifier adapted to be connected to a three-phase alternating current electrical power source and to provide a rectified DC output voltage, and a plurality of inverters, each coupled to the DC voltage output of the rectifier. A lighting apparatus for supplying DC voltage electrical power to a plurality of lamps from a three-phase AC power source is also disclosed. The lighting apparatus includes a three-phase rectifier adapted to be connected to a three-phase alternating current electrical power source and to provide a rectified DC output voltage. The DC voltage output is supplied on positive and negative conductors and a ground conductor.

A plurality of inverters, each having input terminals connected to the positive and negative conductors from the rectifier and a ground terminal connected to the ground conductor from the rectifier. The rectifier is mounted remotely from each of the plurality of inverters.

### BRIEF DESCRIPTION OF THE DRAWINGS

The following drawing describes by illustration the advantages and features of the present invention in which:

FIG. 1. is a block diagram of a lighting system using a multi-ballast AC-to-DC converter according to the present invention;

FIG. 2. is a schematic diagram of the three-phase AC-to-DC converter sub-system of the lighting system using a multi-ballast AC-to-DC converter according to the present invention;

FIG. 3. is a block diagram of the DC-powered electronic ballast sub-system of the lighting system using a multi-ballast AC-to-DC converter according to the present invention;

FIG. 4. is a graph depicting a typical three-phase input voltage to the lighting system using a multi-ballast AC-to-DC converter according to the present invention;

FIG. 5. is a graph depicting a typical DC output voltage of the three-phase AC-to-DC converter sub-system system of the lighting system using a multi-ballast AC-to-DC converter according to the present invention; and

FIG. 6. is a graph depicting a typical AC input current for one phase of the three-phase AC power source used to power the lighting system using a multi-ballast AC-to-DC converter according to the present invention.

### DETAILED DESCRIPTION OF THE INVENTION

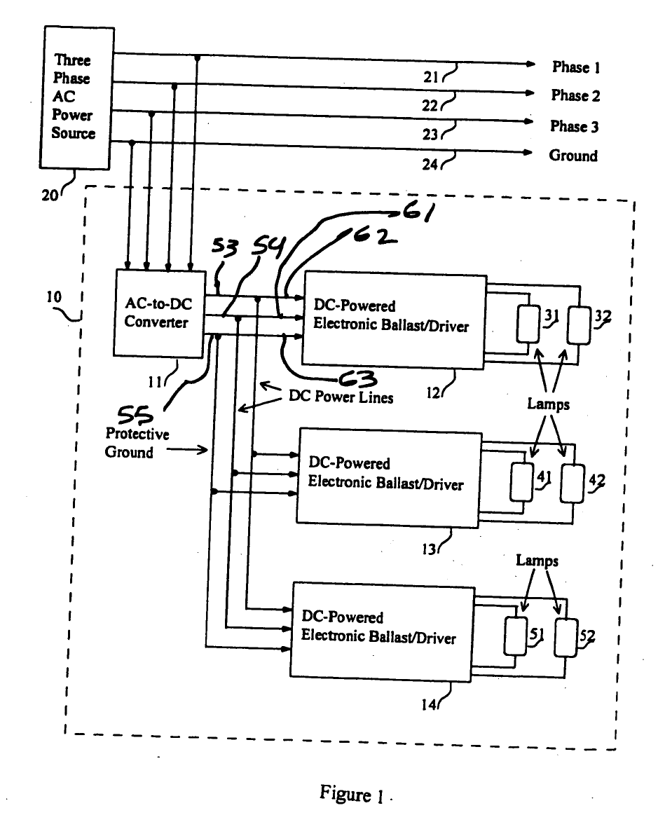

Referring now descriptively to drawing, FIGS. 1-6, there is depicted a lighting system with a multi-ballast AC-to-DC converter.

FIG. 1 illustrates a lighting system 10 with a single multi-ballast AC-to-DC converter 11 and three DC-powered ballasts 12, 13, 14, each driving two discharge lamps 31 and 32, 41 and 42, and 51 and 52, respectively, according to the present invention.

The present invention generally comprises one AC-to-DC converter 11 and one or more electronic ballasts 12, 13, 14 or drivers designed to operate electrically powered lamps such as discharge 31, 32, 41, 42, 51 and 52 lamps, including fluorescent lamps, metal halide lamps, high pressure sodium lamps, or high pressure mercury lamps; or solid state lamps, such as light emitting diodes LEDs or organic light emitting diodes OLEDs. The electronic ballasts or drivers 12, 13, 14 are each designed to be powered by direct current DC. The AC-to-DC converter 11 contains six rectifiers 41-46 and is designed to draw power from three-phase power source 20. The output of the AC-to-DC converter 11 is low-ripple DC, and the AC-to-DC converter is designed to operate one or more electronic ballasts or drivers 12, 13, 14. The input of an individual AC-to-DC converter 11 is connected to a source 20 of three-phase AC power, while the output of the AC-to-DC converter 11 is connected to one or more DC-powered ballasts or drivers 12, 13, 14. The AC-to-DC converter 11 may be centrally located near the source 20 of three-phase AC power, while the DC power is transmitted to the DC-powered ballasts or drivers 12, 13, 14 over reasonable long distances using two conventional wires plus a protective ground. The present invention can also be used with electronic equipment other than lighting equipment such as, but not limited, to computer servers.

FIG. 1 shows one aspect of a lighting system 10 with a multi-ballast AC-to-DC converter 11 connected to a three-phase power source 20. This embodiment has a single AC-to-DC converter 11 and a plurality of DC-powered ballasts 12, 13, 14, with three ballasts shown by example, only, each of the ballasts driving two discharge lamps 31, 32, 41, 42, 51, 52. The three-phase power source has three AC power leads 21, 22, 23, the output voltage on each of the three leads being offset from the output voltage on the other two leads by 120 degrees. The three-phase power source also has a protective ground 24 in accordance with standard electrical safety regulations. In other aspects, the present invention may have more than one AC-to-DC converter 11, more or less than three DC-powered ballasts or drivers 12, 13, 14 operating from each AC-to-DC converter 11, and more or less than two lamps 31, 32, etc., which may or may not be discharge lamps, operating from each DC-powered ballast or driver 12, 13, 14.

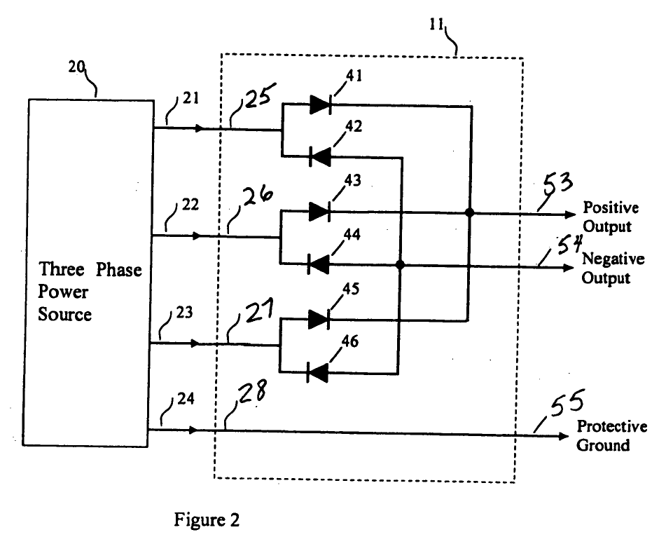

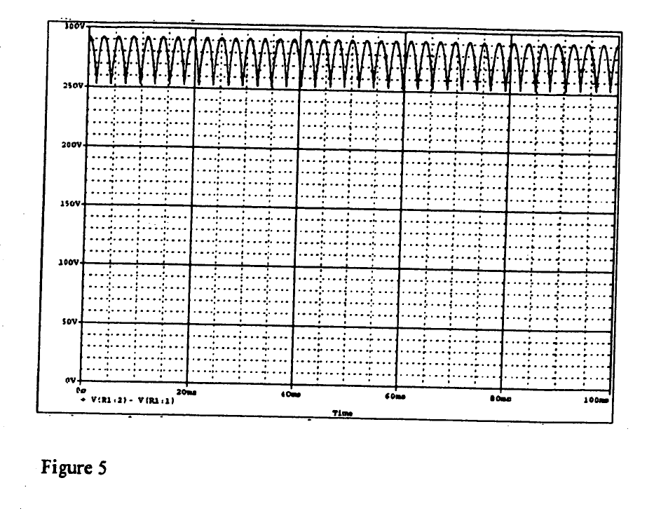

FIG. 2 shows a schematic diagram of an aspect of the three-phase AC-to-DC converter 11. The three-phase AC-to-DC converter 11 has three AC power input terminals 25, 26, 27 that are connected to the respective power output terminals 21, 22, 23 of the three-phase power source 20. The three phase AC-to-DC converter 11 also includes an input terminal 28 and output terminal 55 for the protective ground provided by terminal 24 on the three-phase AC power source 11. The AC-to-DC converter contains six power diode rectifiers 41-46 connected in a full-wave configuration so that the AC power provided on input terminals 25, 26, 27 is transformed into low-ripple DC on output terminals 53, 54. The specific and desirable characteristics of this DC voltage will be described with reference to FIG. 5. In one aspect, the three-phase AC-to-DC converter 11 can be constructed in a standard three-phase circuit breaker housing so that the AC-to-DC converter 11 can be easily and quickly installed in a power distribution panel that is provided with three-phase AC power.

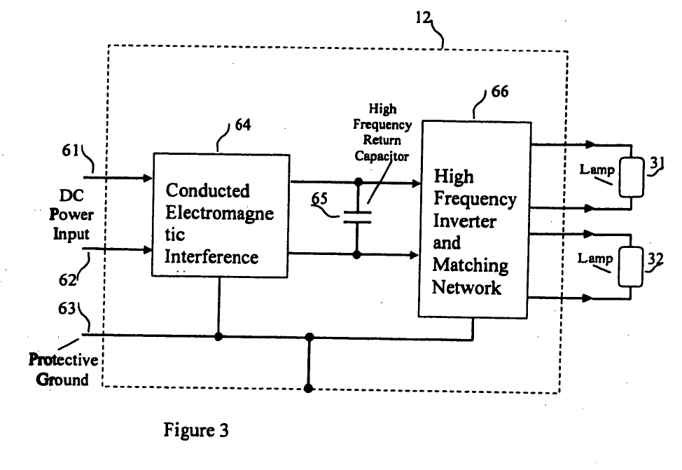

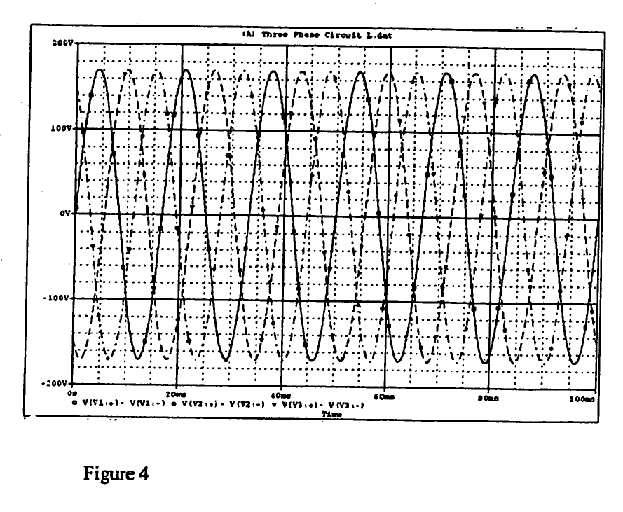

FIG. 3 shows the block diagram of one of the DC-powered electronic ballasts 12. The DC-powered electronic ballast 12 contains a high frequency inverter and matching network 66 that provides regulated high frequency power to one or more lamps. In this aspect, the DC-powered ballast is operating two lamps 31, 32. The DC-powered electronic ballast/driver receives DC power from the AC-to-DC converter 11 via DC power input terminals 61, 62 and is connected to the protective ground via terminal 63. One part of the high frequency inverter 66 is a high frequency return capacitor 65, which is shown separately from the high frequency inverter/matching network block to emphasis its importance. Because the DC-powered electronic ballast/driver 66 may be located a long distance from the AC-to-DC converter 11, it is desirable that the high frequency return capacitor 65 be mounted in or very close to the high frequency and matching network 66 to insure consistent operation that is independent of the distance between the DC-powered ballast/driver 12 and the AC-to-DC converter 11. Due to the physical separation between the DC-powered ballast/driver 12 and the AC-to-DC converter 11 an electromagnetic conducted interference filter 64 is included in the DC-powered ballast 12. The conducted electromagnetic interference filter 64 prevents high frequency signals generated by the high frequency inverter 66 from flowing on the power lines connecting the DC-powered ballast/driver 12 and the AC-to-DC converter 11. If these high frequency signals are allowed to flow out from power input terminals 61, 62, they can cause radiated electromagnetic interference from the power lines connecting the DC-powered ballast/driver 12 to the AC-to-DC converter 11 and also create conducted electromagnetic interference where the AC-to-DC converter 10 is connected to the three-phase AC power source 20. FIG. 4 illustrates the input voltage to the three-phase AC-to-DC converter 11. For this example, a 60 Hz three-phase voltage source with a magnitude of 120 volts RMS was used, which results in three sine wave input voltage waveforms, each with peak values of +170 volts and −170 volts and with each waveform offset from the other two by 120 degrees. FIG. 5 illustrates the DC output voltage of a three-phase AC-to-DC converter 11 of the type described in FIG. 2 when powered by the waveform shown in FIG. 4 and connected to a 100 Ohm resistive load. As shown in FIG. 5, the DC output voltage of the AC-to-DC converter 11 when driven by a 120 volt RMS three-phase power source 20 has a peak voltage of 294 volts and the 360 Hz ripple has a peak-to-peak voltage of about 40 volts. Mathematical analysis of the waveform shown in FIG. 5 show that the DC output voltage had a mean value of 279 volts and the 360 Hz ripple has an RMS value of 16 volts, which is only 5.7% of the mean DC value. The three-phase AC-to-DC converter 11 produces DC voltage with a very fractional ripple without the use of a power line frequency energy storage capacitor. Power line frequency energy storage capacitors are the most failure prone components in most electronic systems, including lighting systems, and, if used, will usually create input current distortion and very power input power factor.

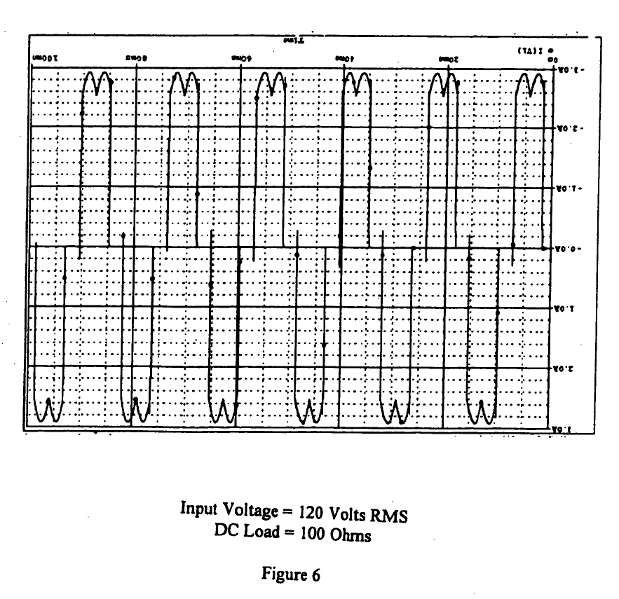

FIG. 6 illustrates the Phase 1 current waveform for a 120 volt RMS 60 Hz source as described in FIG. 4 connected to an AC-to-DC converter 11 as described in FIG. 2. The Phase 1 current is the current flowing into terminal 25 of AC-to-DC converter 11. For the calculations shown in FIG. 6, the output terminals 53, 54 of the AC-to-DC converter 11 were connected to a 100 Ohm DC resistor. The narrow spikes which are visible near the zero-crossings of the input current waveform at approximately 7 msec, 15 msec, 32 msec and so on, are artifacts of the calculations and are not expected to be present in the actual circuit. While this input current is not sinusoidal, calculations show that the input power factor of this circuit, defined as the input power divided by the product of the RMS voltage times the RMS input current, is greater than 0.95, which easily exceeds the requirement that lighting equipment used in commercial and industrial buildings have an input power factor of 0.9 or greater. Since the circuit is symmetrical, the input power factor for the other two AC power inputs will be the same as for the one calculated. This demonstrates that the three-phase AC-to-DC converter 11 provides a high input factor without the use of power factor correction circuitry. Power factor correction circuitry increases the cost and reduces the electrical efficiency of systems, so systems such as this invention that do not need power factor correction circuits will have improved efficacy and reduced cost compared to prior art systems.

It will also be understood that, in addition to being used with electronic ballasts or drivers to operate lamps of various types, the present invention can be used to power any type of electronic equipment that can operate from DC power, including computers and computer servers and similar equipment.

What is claimed is:

1. An apparatus for supplying power from a three-phase AC electrical power source to an AC load comprising:
a three-phase rectifier adapted to be connected to a three-phase alternating current electrical power source and to provide a rectified DC output voltage; and
a plurality of high frequency inverters, each coupled to the DC voltage output of the rectifier, each inverter adapted to power at least one AC load.

2. The apparatus of claim 1 wherein the at least one AC load is at least one electrically powered lamp.

3. The apparatus of claim 1 further comprising a high frequency return capacitor coupled across DC input connections of the inverter, between the inverter and the output of the rectifier.

4. The apparatus of claim 3 further comprising:
an electromagnetic interference filter coupled between the capacitor and the output of the rectifier.

5. The apparatus of claim 1 further comprising:
an electromagnetic interference filter coupled between each inverter and the output of the rectifier.

6. The apparatus of claim 1 wherein the rectifier comprises:
a full wave bridge.

7. The apparatus of claim 6 wherein the full wave bridge is formed of six interconnected diodes.

8. The apparatus of claim 1 wherein the DC voltage output of the rectifier comprises:
a positive output lead, a negative output lead and a ground lead

9. The apparatus of claim 1 wherein:
the rectifier is located remote from the inverters.

10. A lighting apparatus for supplying electrical power to a plurality of lamps from a three-phase AC power source, the lighting apparatus comprising:
a three-phase rectifier adapted to be connected to a three-phase alternating current electrical power source and to provide a rectified DC output voltage, the DC voltage output supplied on positive and negative conductors and a ground conductor;
a plurality of inverters, each inverter having input terminals connected to the positive and negative conductors from the rectifier and a ground terminal connected to the ground conductor from the rectifier; and
the rectifier mounted remotely from each of the plurality of inverters.

11. The lighting apparatus of claim 1 wherein:
the rectifier is mounted in a circuit breaker panel adapted to be coupled to the three-phase AC power source; and
each of the plurality of inverters is mounted in proximity with one lamp fixture containing at least one lamp.

12. The lighting apparatus further comprising:
a high frequency return capacitor coupled to each inverter, the capacitor mounted in close proximity to each inverter.
